(19) United States
(12) Patent Application Publication
(10) Pub. No.: US 2005/0036692 A1
(43) Pub. Date: Feb. 17, 2005

(54) Method and device for determining time-of-photograph of individual image, and image retrieving method and computer program for the method

(76) Inventors: Takayuki Iida, Kanagawa (JP); Yoichi Nakamura, Kanagawa (JP); Masaki Takamatsu, Kanagawa (JP); Shizuo Habuta, Tokyo (JP); Tatsuya Konagaya, Kanagawa (JP)

Correspondence Address: BIRCH STEWART KOLASCH & BIRCH, PO BOX 747, FALLS CHURCH, VA, 22040-0747, US

(21) Appl. No.: 10/852,197

(22) Filed: May 25, 2004

(30) Foreign Application Priority Data
May 26, 2003 (JP) 2003-147219
Jul. 9, 2003 (JP) 2003-194017

(51) Int. Cl. G06K 9/60; G06F 17/30

(52) U.S. Cl. 382/217; 382/305; 348/231.3; 348/231.5; 707/104.1; 382/278

(57) ABSTRACT

In a photo digitizing system, the date-of-photograph of each individual image is extracted from image data, and is recorded in association with each image data on a storage medium. If the date-of-photograph of a print image cannot be determined based on its own data, a corresponding film image is retrieved by comparing the image data of the print image to image data of each of the film images, and the date-of-photograph of the corresponding film image is determined to be the date-of-photograph of the concerned print image. When the customer adds a tag to any one of the digitized images, data of the tag is recorded in a customer IDX file in relation to a frame number of that image. To retrieve some images from the storage medium by use of a search term, those frame numbers which are related to tag data that match with the search term are extracted in the customer IDX file, so the images having the extracted frame numbers are displayed.

### FIELD OF THE INVENTION

The present invention relates to a method of determining time-of-photograph of each individual print image that is picked up as digital image data from a photo print, and an apparatus for embodying this method.

The present invention relates also to a method of retrieving image data from a storage medium and displaying images on the basis of the retrieved image data. Furthermore, the present invention relates to a computer program for causing a computer to carry out the image retrieval.

### BACKGROUND OF THE INVENTION

Photo digitizing services have been known as a system that digitizes images photographed on photographic film and paper, and writes consequent digital image data on storage media, such as CD (compact disk) and DVD (digital versatile disk). The customer who ordered the photo digitizing gets the storage medium storing the image data when the original photographic images are returned.

The customer can appreciate the digitized images on a monitor screen based on the image data read out from the storage medium by use of a reproduction device, such as a personal computer. A photo digitizing system is disclosed for example in Japanese Laid-open Patent Application No. Hei 10-150538.

Digitizing photographs has advantages that the quality of digital images will hardly deteriorate with age, and that a large number of photographs can be stored in a compact style. For these reasons, the photo digitizing services are getting popular these days. In addition, capacities of recent storage media are getting so large that a single storage medium can store image data of more than thousand frames. As a result, so-called total digitizing service has started recently, wherein the customer can order the photo digitizing of a large number of photo prints and photo filmstrips, which have been accumulated by the customer for a long time. Then, image data obtained from the large number of photographic images are written together in a storage medium.

For the photo digitizing, a photo digitizer is used. As disclosed for example in Japanese Laid-open Patent Application No.2002-354385, a photo digitizer is constituted of a film scanner for opt-electrically reading images from photo filmstrips, a print scanner for opt-electrically reading images from photo prints, and a media driver for writing image data, as picked up through these scanners, on a storage medium. The image data are converted into image files of JPEG (Joint Photographic Experts Group) format before writing on the storage medium.

In the total digitizing service, for the purpose of adding values to this service, it is studied to provide the digitized image data with additional data of when each image was photographed. With such additional time-of-photograph data, the customer can sort the image files, as read out from the storage medium, according to their time-of-photograph, or can display the images in the order of time of photograph, either in a matrix arrangement or in an automatic one-by-one display. This contributes to widening the way of enjoying the photographs. In order to determine the time-of-photograph, it is the most practical to extract the date-of-photograph, which can often be superimposed on individual printed image or individual picture frame of photographic film, from image data through the character recognition. Hereinafter an image picked up from a photo print will be referred to as a print image, and an image picked up from a picture frame will be referred to as a film image.

However, character recognition is generally difficult when the color of superimposed characters is equivalent or similar to the color of their background. In that case, the success rate of date extraction is lowered. Especially, because the photographic paper has a narrower latitude or dynamic range in comparison with the photographic film, the success rate of date extraction from the print images is lower than that from the film images. In other words, there is a problem that a certain number of print images can probably be left undetermined about their time-of-photograph.

On the other hand, because the monitor can display a limited number of images at a time on the screen, the customer has to operate cursor keys or a mouse in order to have a desired image displayed on the screen. If there are hundreds of image files in a storage medium, it can take a certain time for the customer to find out the desired image.

It is known that image data files of the Exif (Exchangeable Image File) format are provided with a storage area for additional data or tag data, so that the user can write appropriate data in this area. These tag data may be used for retrieving desired images. However, where the number of image data files is huge, the time taken for reading out the tag data themselves is going to be so long that the customer has to wait for a long time till the end of retrieval.

In addition, it is desirable that a single storage medium stores not only those image data which are obtained by digitizing photo prints or picture frames on photographic film, but also still video data or movie data obtained by digitizing pictures on movie film, e.g. single-8 film. Then, the customer can enjoy watching different kinds of images just by setting the single storage medium in a personal computer or the like.

However, it has been impossible to add tag data to movie data, which are not adapted to the Exif format, or to some kinds of still video data. Concerning those images having no tag data, all image files must be read out to retrieve a desired image frame. Since the movie data consist of a huge number of image frames, it is time- and labor-consuming to find out a desired image frame.

### SUMMARY OF THE INVENTION

In view of the foregoing, a primary object of the present invention is to provide a method of determining time-of-photograph of each digitized image, so as to reduce such images whose time-of-photograph is undetermined.

A secondary object of the present invention is to provide an apparatus for embodying the time-of-photograph determination method of the invention.

Another object of the present invention is to provide a method of adding tag data to image data files at a high efficiency.

A further object of the present invention is to provide a method of retrieving image at a high efficiency even while there are different kinds of image data files.

The present invention further has an object to provide a computer program for causing a computer to carry out the high efficiency image retrieval.

To achieve the above and other objects, according to a first invention, a method of determining time-of-photograph of an individual image in a photo digitizing process, wherein print images recorded as photo prints and film images recorded on photographic film are opt-electrically converted into digital image data to record the image data on a storage medium, the method comprises the steps of:
judging similarity between two images by comparing image data of a particular print image whose date-of-photograph is not determined with image data of each of a plurality of film images, to retrieve from the film images a film image that can be judged to be corresponding to the particular print image; and determining that the date-of-photograph of the film image as judged to be corresponding to the particular print image is the time-of-photograph of the particular print image.

According to a preferred embodiment, the method of determining time-of-photograph further comprises steps of extracting date-of-photograph of each individual image that may be superimposed on the image from image data obtained from the print images and the film images, and recording extracted date-of-photograph as date data in association with the image data.

It is preferable to predetermine a first similarity level and a second similarity level lower than the first similarity level, so that a film image is judged to be a corresponding image to the particular print image when the similarity of the film image to the particular print image is on the first similarity level. If the corresponding image is not detected, at least a film image is extracted as a similar image to the particular print image when the similarity of the at least a film image to the particular print image is on the second similarity level. In that case, data of the similar image, preferably a data file name of the similar film image, is recorded in association with data of the particular print image.

According to the present invention, a device of determining time-of-photograph of an individual image in a photo digitizing apparatus, comprises an image retrieving device that compares image data of a particular print image whose date-of-photograph is not determined, with image data of each of a plurality of film images, to judge similarity of the film images to the particular print image, and retrieves from among these film images a film image that can be judged to be corresponding to the particular print image; and a device of determining that the date-of-photograph of the film image as judged to be corresponding to the print image is the time-of-photograph of the particular print image.

According to a preferred embodiment, the image retrieving device judges a film image to be a corresponding image to the particular print image when the similarity of the film image to the particular print image is on a predetermined first similarity level. If the corresponding image is not detected, the image retrieving device judges at least a film image to be a similar image to the particular print image when the similarity of the at least a film image to the particular print image is on a second similarity level that is predetermined to be lower than the first similarity level, and records data of the similar image in association with data of the particular print image.

According to a second invention, a method of retrieving images from among a plurality of image data files written on a storage medium by use of search terms, comprising the steps of:
allocating identification data, such as frame numbers, respectively to the plurality of image data files; creating an index file that correlates the identification data with tag data; revising the index file each time tag data is added to one of the image data files; searching the index file for tag data that match with a search term entered, to extract those of the identification data which are correlated with the matching tag data; and reading out image data files with reference to the extracted identification.

The search terms include keywords classifying image contents and date data.

According to a preferred embodiment, the plurality of image data files include files of those formats having an additional data recording area on which tag data are recordable, and files of those formats having no additional data recording area. In that case, tag data are recorded in the additional data recording area as for the image data files having the additional data recording area. On the other hand, as for those image data files having no additional data recording area, tag data are recorded in the index file in relation to the identification data of those image data files which the tag data are allocated to.

Concerning those image data files having the additional data recording area, it is preferable not to create the index file until the number of the image data files comes to a preset value. Before the index file is created, image data files are retrieved by comparing the entered search term with tag data recorded in the additional data recording area of the image data files.

A computer program of the present invention, for retrieving images from among a plurality of image data files written on a storage medium by use of search terms, comprises program segments for causing a computer to carry out the steps of:
allocating identification data respectively to the plurality of image data files; creating an index file that correlates the identification data with tag data; revising the index file each time tag data is added to one of the image data files; searching the index file for tag data that match with a search term entered, to extract those of the identification data which are correlated with the matching tag data; and reading out image data files with reference to the extracted identification data.

According to the time-of-photograph determining method of the invention, if the date-of-photograph of a print image cannot be detected, a corresponding film image to that print image is searched for by comparing image data of that print image with image data of each of a plurality of film images, and the date-of-photograph of the corresponding film image is determined to be the date-of-photograph of that print image. Thus, the number of those print images whose time-of-photograph is undetermined is reduced.

Even while there is not a corresponding film image to the print image, if data of similar film images to the print image are recorded, the customer can determine the date-of-photograph of that print image with reference to the date-of-photograph of any of these similar film images.

According to the image retrieving method of the invention, because the index file is created to correlate the identification data of the respective image data files with tag data, and the tag data that match with the entered search term is searched for in the index file, it is possible to retrieve image data files having the matching tag data with reference to the identification data. Therefore, even where there are huge numbers of image data files on the storage medium, desired image data files are efficiently retrieved. Moreover, if the storage medium stores those image data files having no recording area for the tag data, because the tag data may be recorded in the index file in relation to the identification data of those image data files, desired image data files can be retrieved with high efficiency regardless of the file format.

Concerning those image data files having the additional data recording area for the tag data, because the image data files can be retrieved by comparing the entered search term with the tag data recorded in the additional data recording area, it is preferable not to create the index file until the number of the image data files comes to a preset value, in order to save the data processing time necessary for revising the index file.

### BRIEF DESCRIPTION OF THE DRAWINGS

The above and other objects and advantages will become more apparent from the follow detailed description of the preferred embodiments when read in connection with the accompanied drawings, wherein the same or like components are designated by the same reference numerals throughout all figures, wherein:

FIG. 1 is a schematic diagram illustrating photo digitizing services;

FIG. 2 is an explanatory diagram illustrating a data storage structure inside a storage medium;

FIG. 3 is a basic block diagram of a photo digitizer;

FIG. 4 is an explanatory diagram illustrating a format of an image file;

FIG. 5 is a flowchart illustrating an overall sequence of time-of-photograph determination process;

FIG. 6 is a flowchart illustrating a sequence of processing print images whose dates of photograph cannot be extracted from their own image data;

FIG. 7 is a flowchart illustrating a sequence for retrieving similar film images to a print image;

FIGS. 8A and 8B are explanatory diagrams illustrating an example of how the similar film images are related to the concerned print image;

FIG. 9 is an explanatory diagram illustrating an example of screen page displayed for time-of-photograph determination;

FIG. 10 is a schematic block diagram illustrating a photo digitizing process, according to another embodiment of the invention;

FIG. 11 is an explanatory diagram illustrating a file structure in a DVD;

FIG. 12 is an explanatory diagram illustrating a structure of a customer index file;

FIG. 13 is an explanatory diagram illustrating a menu page of an image display program;

FIG. 14 is an explanatory diagram illustrating a screen page displayed in an image display mode;

FIG. 15 is an explanatory diagram illustrating a file structure of combined data of two DVDs;

FIG. 16 is an explanatory diagram illustrating another file structure of combined data of two DVDs;

FIG. 17 is an explanatory diagram illustrating a file structure of a DVD, storing image data files of different formats;

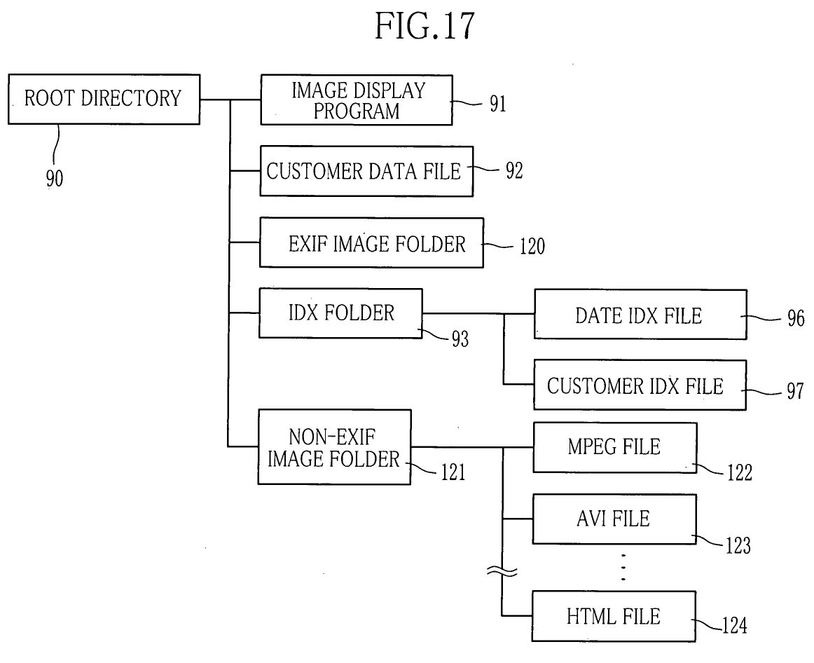

FIG. 18 is a flowchart illustrating a sequence of image retrieval by use of tag data; and

FIG. 19 is an explanatory diagram illustrating a file structure of a DVD, having a plurality of index files for different tag genres.

### DESCRIPTION OF THE PREFERRED EMBODIMENTS

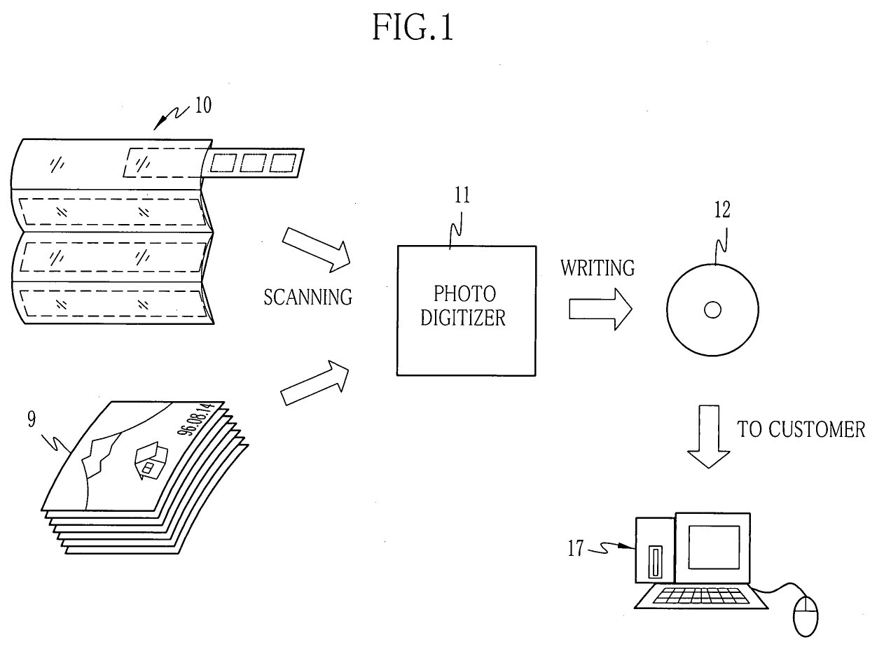

As shown in FIG. 1, an agent receives photo prints 9 or negative filmstrips 10 from customers, in order to digitize picture frames photographed on the photo prints 9 and the negative filmstrips 10. The picture frames are scanned by a photo digitizer 11 for obtaining digital image data, and the image data of the picture frames are recorded on storage media, for example, on a DVD (Digital Versatile Disc) 12.

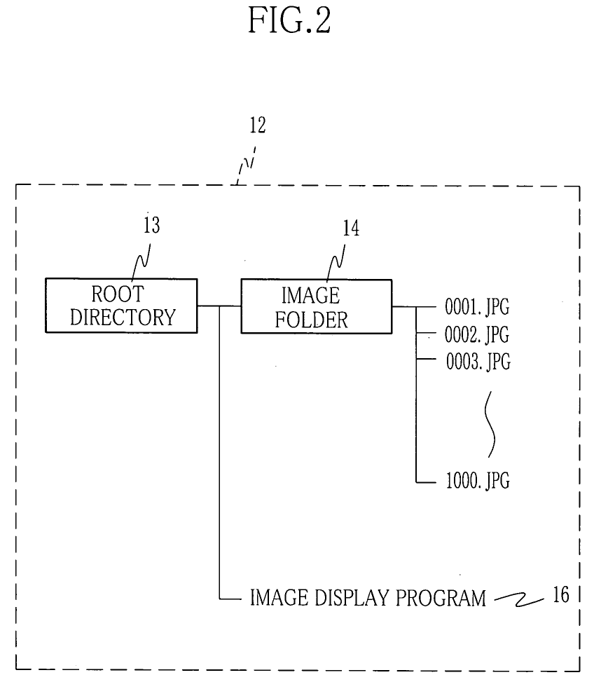

In the DVD 12, as shown in FIGS. 2, an image folder 14 is created under a root directory 13, and the image data is stored in this image folder 14. In addition, image display program 16 is stored under the root directory 14, for use in reproducing the image data. The DVD 12 having the image data and the image display program 16 recorded thereon is forwarded to the customer.

The customer can view the photographs on a personal computer 17 or the like, by reproducing the image data from the DVD 12. In this embodiment, a computer main body of the computer 17 is equipped with a media drive that is adapted to the DVD 12. The computer main body is also connected to a display, and a console consisting of a keyboard and a mouse. A CPU of the computer 17 performs the image display program in response to command signals from the console, to have the display device display images based on the image data.

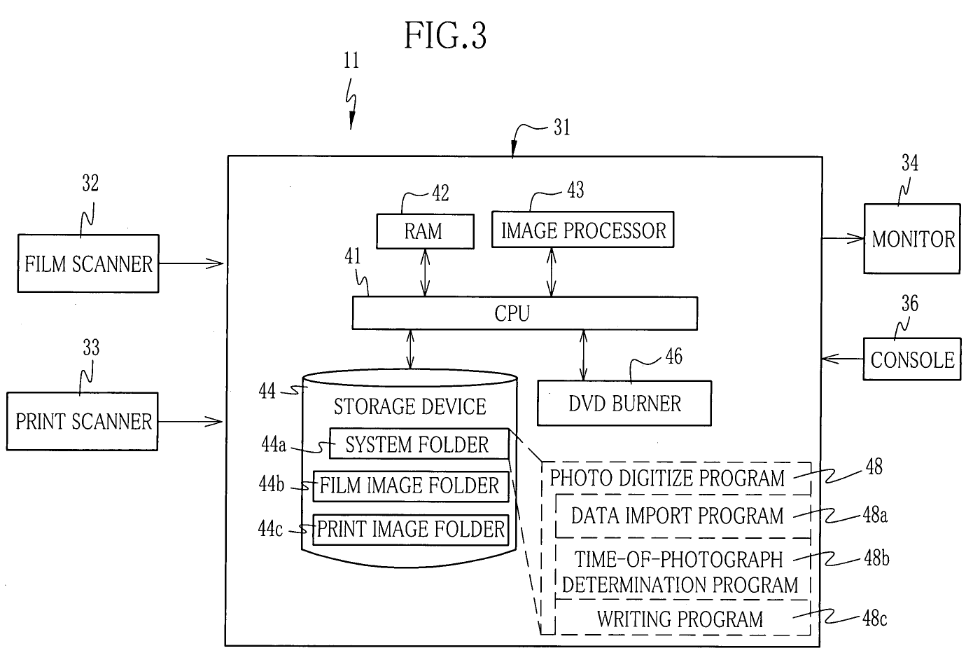

FIG. 3 shows a conceptual structure of the photo digitizer 11. The photo digitizer 11 is constituted of a main body 31, a transparent type film scanner 32, a reflective type print scanner 33, a monitor 34 and a console 36. The film scanner and the print scanner 33 are connected to the main body 31, for example, through an SCSI interface, so that the scanners 32 and 33 outputs the image data to the main body 31, while the main body 31 sends control signals to the scanners 32 and 33.

The film scanner 32 scans the picture frames on the negative filmstrip 10 opt-electrically through a CCD sensor. The print scanner 33 scans the pictures on the photo prints 9 opt-electrically through a CCD sensor. Analog picture signals from the respective CCD sensors are converted into digital image data through an A/D converter, and the subsequent image data are sent to the main body 31.

The main body 31 is configured on the basis of a computer main body of a workstation or a personal computer, and is constituted of a CPU 41, a RAM 42, an image processor 43, a storage device 44, and a DVD burner 46. The CPU 41 performs various programs stored in the storage device 44, and controls respective portions of the photo digitizer 11. The RAM 42 serves as a work memory used by the CPU 41 to execute the programs. The image processor 43 performs image-processing of various kinds on the image data from the film scanner 32 and the print scanner 33. The processed image data is stored in the storage device 44. The DVD burner 46 writes the stored image data and the image display program 16 on the DVD 12.

An example of the storage device 44 is a hard disc drive (HDD). The storage device 44 is provided with a system folder 44a, a film image folder 44b and a print image folder 44c. The system folder 44a stores an operating system, a photo digitize program 48, and other various programs, including driver software for controlling the film scanner 32 and the print scanner 33.

The photo digitize program 48 is composed of a data import program 48a, a program 48b for determining time-of-photograph of each image, a data writing program 48c and other programs. The data writing program 48c is used for the CPU 41 to read out the imported image data from the storage device 44, and write the read image data on the DVD 12 by use of the DVD burner 46. Using the data import program 48a, the CPU 41 imports image data from the scanners 32 and 33, processes the imported image data through the image processor 43, and stores the processed image data in the storage device 44.

Where to store the imported image data in the storage device 44 is determined depending upon their origin, i.e. where the image data is imported from. That is, film image data picked up from the negative filmstrip 10 through the film scanner 32 are stored in the film image folder 44b. On the other hand, print image data picked up from the photo prints 9 through the print scanner 33 are stored in the print image folder 44c.

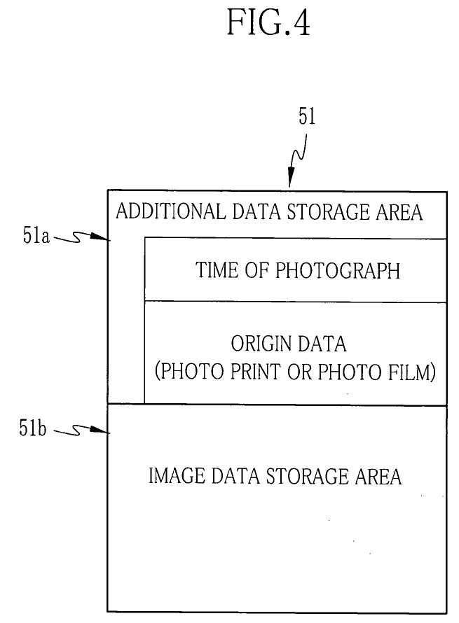

The imported image data are converted into image files 51 of a format as shown, for example, in FIG. 4. The image file 51 is provided with an image data storage area 51a for storing the image data and an additional data storage area 51b for storing additional data. The image data is stored in the image data storage area 51a, after being compressed to JPEG format. The additional data include time data, that is, the time or date-of-photograph of individual pictures, and origin data, that is, whether the image data are picked up from a photo print or a photo filmstrip. The origin data are stored, for example, in the respective image files 51 at the time of data import.

Using the time-of-photograph determination program 48b, the CPU 41 performs processes for determining the time-of-photograph of each individual picture. In many cases, the date-of-photograph is superimposed on each individual picture frame on the negative filmstrip 10 or on each individual photo print 9. Therefore, the time-of-photograph is determined primarily by extracting the superimposed date-of-photograph from the image data. For example, film image data picked up from a picture frame on the negative filmstrip 10 is analyzed to extract pixels of the superimposed date, and the extracted pixels are converted into text data through a character recognition process. The date extracted in this way is determined as the date-of-photograph of this film image. In the same way, print image data picked up from a photo print 9 is analyzed to extract the superimposed date-of-photograph. The date-of-photograph determined in this way is stored in the additional data storage area 51b of the image file 51.

However, because of a difference in latitude between the negative filmstrip 10 and photographic paper, the success rate of date extraction from the print images is lower than that from the film images. For this reason, those print images whose date-of-photograph cannot be extracted, are submitted to a secondary process. In the secondary process, a film image corresponding to each individual of those print images is searched, and if there is a corresponding film image, the date-of-photograph is extracted from data of that film image. The date extracted in this way is determined as the time-of-photograph of that print image. So the time-of-photograph can be determined with respect to those print images whose date-of-photograph cannot be extracted in the primary process.

Needless to say, there are film images where the superimposed date-of-photograph is difficult to extract as it has the same color as its background has. However, since the film image can be scanned in a three-color separation method using transparent light of the three primary colors: red, green and blue, it is possible to extract the date-of-photograph if only there is a little color difference between the date and its background.

In the secondary process, the CPU 41 compares the print image data to the film image data, for detecting similarity of the print images to the film images. Reference level for estimating similarity between a print image and a film image are preset. As for image structures, the similarity level is predetermined to be approximately 100%. As for colors, because the speed of color deterioration or fading of the print image is different from that of the film image, there will be some color difference even between the print image and its corresponding film image, as a result of aging. In addition, because of stains or dusts, densities of respective pixels of the print image can differ from those of the corresponding film image. For these reasons, tolerance margins are provided for colors in consideration of the difference in fading degree and the density difference resulted from stains or dusts. A film image, which satisfies the predetermined similarity level with respect to a print image, is estimated to be correspondent with that print image.

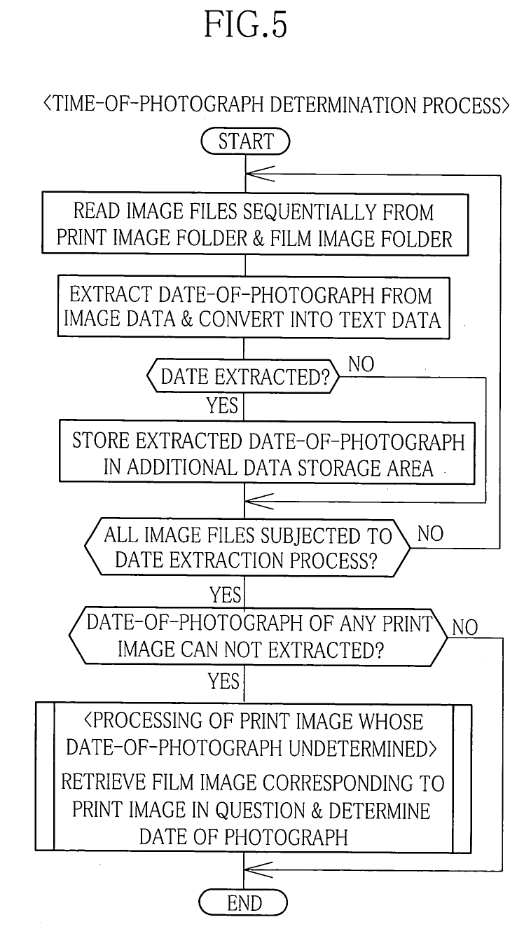

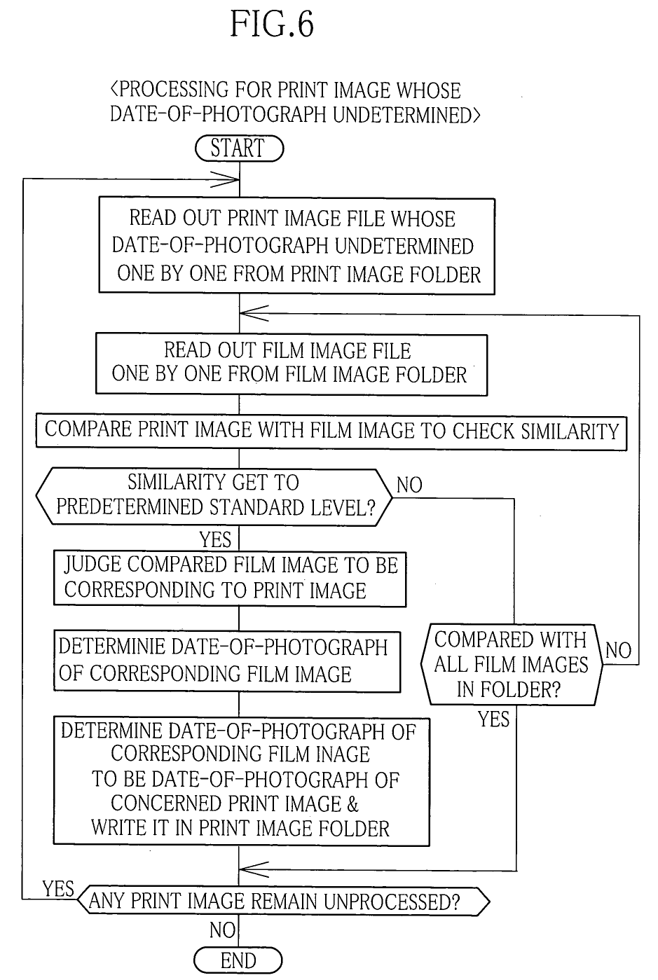

Now the operation of the above configuration will be described with reference to flowcharts of FIGS. 5 and 6.

An operator of the photo digitizer 11 picks up the film image data and the print image data from the negative filmstrip 10 and the photo prints 9 by use of the film scanner 32 and the print scanner 33. The picked up film image data is stored in the film image folder 44b, and the picked up print image data is stored in the print image folder 44c.

After picking up the image data, the operator operates the console 36 to enter a command for starting determination of the time-of-photograph. Then, the CPU 41 performs the time-of-photograph determination process according to the time-of-photograph determination program 48b, as shown in FIG. 5. The CPU 41 reads out the image files from the film image folder 44b and the print image folder 44c, to analyze the image data for extracting the superimposed date-of-photograph. The extracted date data is converted into text data through the character recognition process. The text data of the date-of-photograph is stored in the additional data storage area 51b. The original image file, from which the date-of-photograph is extracted, is rewritten with an image file storing the date-of-photograph data. If the date-of-photograph cannot be extracted, the corresponding image file is not rewritten and left unchanged. The extracting process is executed sequentially on every image file of the film image folder 44b and the print image folder 44c as well.

If there is a print image whose date-of-photograph cannot be extracted from its image data, the secondary process is executed on that print image in order to determine the time-of-photograph of that print image on the basis of a corresponding film image. As shown in the flowchart of FIG. 6, the CPU 41 reads out those image files having no date data stored therewith one after another from the print image folder 44c, and then searches for the corresponding film image to each of these print images among the image files in the film image folder 44b.

The CPU 41 reads out the image file one after another from the film image folder 44b, analyzes and compares one film image data to one print image data, to check the similarity between them. If the degree of similarity is less than the predetermined reference level, the print image data is compared to another film image data. If the similarity gets to the reference level, the compared film image is determined to be correspondent with the print image. Then the date-of-photograph is extracted from this film image, and is stored as the date-of-photograph of that print image in the print image file along with the image data of that print image. As for other print images whose date-of-photograph is not determined, the date extraction process from the film images is executed in the same way. Thus, the number of those print images whose time-of-photograph is undetermined is reduced.

In the above embodiment, the time-of-photograph determination process is ended even while there still remain those print images which cannot find their corresponding film images satisfying the predetermined similarity level. But there may be those images which have the same or similar background to each other even though the similarity level does not get to the predetermined reference level. Those images having the same or similar background can probably be photographed on the same day or in the same period, even if the main subjects are different from each other. Therefore, it is possible to use such a similar image for determining the time-of-photograph of a print image when there is not a corresponding film image to that print image.

In that case, two reference levels are preset for checking similarity. The first level is equivalent to the reference level used for the retrieval of a corresponding film image in the first embodiment, and is used for estimation of correspondence between the film images and the print images. On the other hand, the second level is set lower than the first level, and is used for retrieving similar film images to a print image. In the present embodiment, the second level is designed to find out film images having different main subjects in the same or like background as the print image in question. Those film images which satisfy the second similarity level with respect to the concerned print image are regarded as similar images to that print image.

According to the second embodiment, first a corresponding film image is searched for with reference to the first similarity level, to each of those print images whose date-of-photograph cannot be extracted. The first searching process is executed in the same sequence as shown in the flowchart of FIG. 6, so that the date-of-photograph of the retrieved film image is written as the date-of-photograph of the counterpart print image in the image file of that print image. Thereafter, those print images which do not have any corresponding film images, are compared again to the film images, but using the second similarity level as the reference.

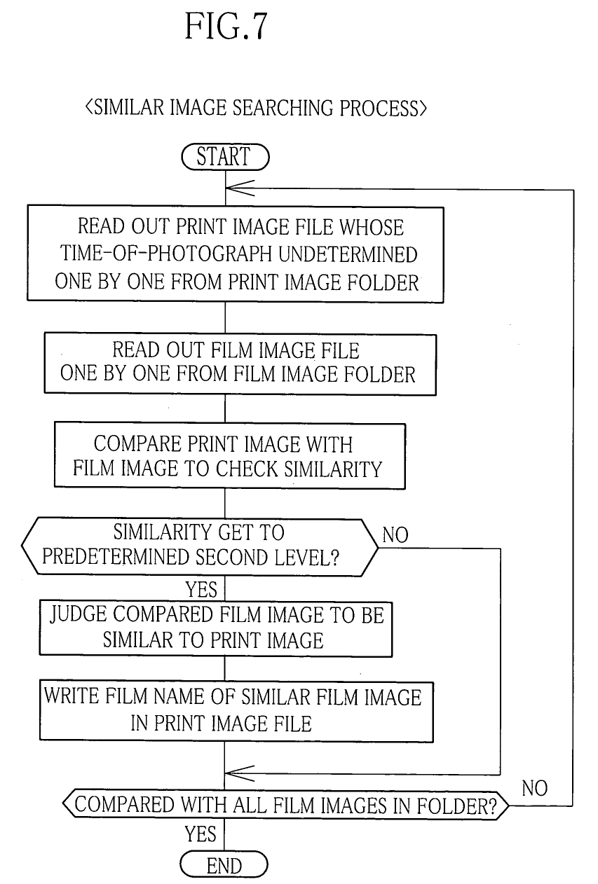

The flowchart of FIG. 7 shows the process of searching for similar film images. Print images whose date-of-photograph is undetermined are sequentially read out from the print image folder 44c. Each of these print images is compared to respective film images of the film image folder 44b, to check the similarity between them. If the similarity level between a film image and a print image reaches the second level, the film image is judged as a similar image to that print image. The similar image is recorded in association with the concerned print image. For example, the file name of the film image that is judged as the similar image is written in the image file of the concerned print image.

As described above, if a film image is detected to be a counterpart of a print image with reference to the first similarity level, the date-of-photograph of this film image is written as the date-of-photograph of the counterpart print image in the image file of that print image. On the other hand, because the film image detected with reference to the second similarity level is just similar to and not correspondent with the concerned print image, it is desirable to leave the customer in charge of the decision on whether to use the date-of-photograph of the similar film image for the date-of-photograph of the concerned print image. For this reason, in the photo digitizing agent, the date-of-photograph of the similar film image is not dealt with as the date-of-photograph of the concerned print image, but the similar film image is just recorded in association with the concerned print image.

Since the second similarity level for detecting the similar images is lower than the first similarity level for detecting the corresponding images, it is probable that a number of film images are detected as the similar images to a print image. In that case, all of these similar film images are recorded in association with the concerned print image. The similar image detection process as above is performed with respect to every one of those print images whose date-of-photograph is undetermined.

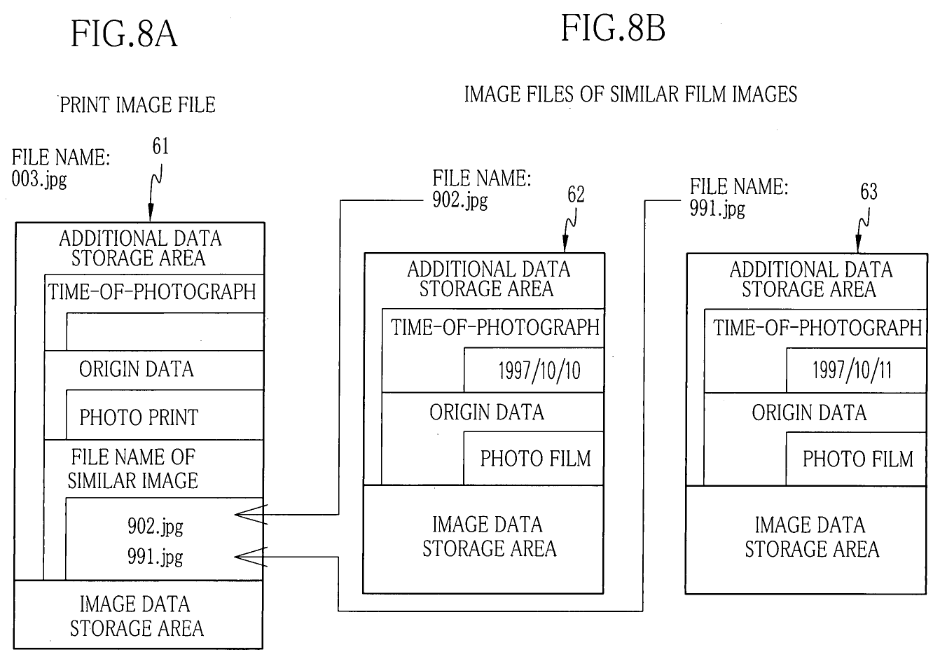

FIGS. 8A and 8B show an example of a print image file having file names of similar film images written therein. Assuming that a couple of film images are detected as the similar images to a print image whose file 61 is named “003.jpg”, file names “902.jpg” and “991.jpg” of the image files 62 and 63 of these film images are written in the additional data storage area of the image file 61 of the print image.

As the file names of the similar film images are written in association with the print image whose date-of-photograph is not determined by the photo digitizing agent, the customer, after receiving the DVD 12, can determine the time-of-photograph of the concerned print image with reference to the similar film images. That is, if the customer confirms that the print image in question was photographed on the same day or in the same period as any of the similar film images was, the customer can determine the date-of-photograph of the concerned print image to be equal to the date-of-photograph of that similar film image.

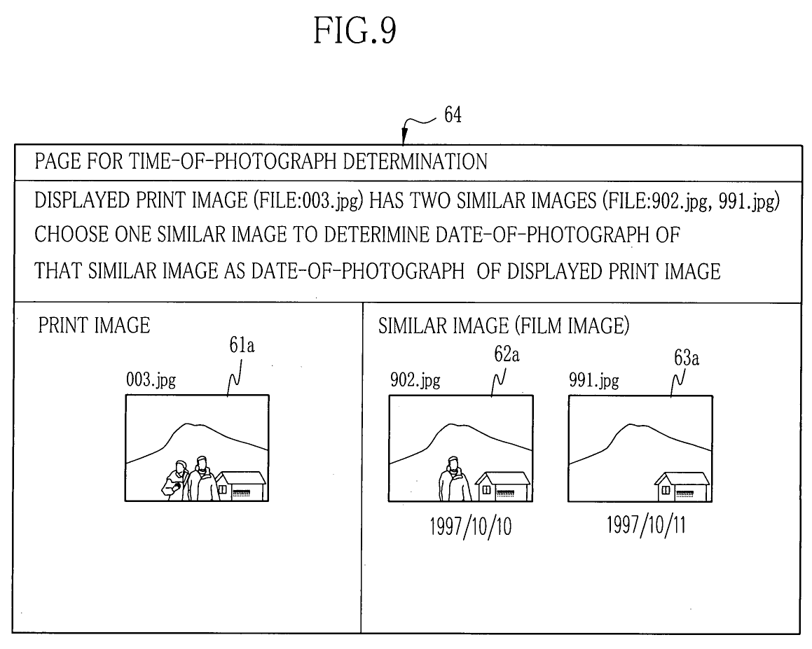

In order for the customer to determine the time-of-photograph, it is preferable to provide the image display program 16 with a time-of-photograph determination function. In that case, the image display program 16 is designed to read out the file names of the similar film images from the print image file 61 whose date-of-photograph is undetermined, and retrieves the film image files 62 and 63 from the image folder 14. FIG. 9 shows an example of a screen page 64 for the time-of-photograph determination. On the time-of-photograph determination page 64, a print image 61a is displayed along with film images 62a and 63a that are judged as the similar images to the print image 61a. When the customer chooses any of the film images 62a and 63a, the date-of-photograph of the chosen film image is written as the date-of-photograph of the print image 61a in the image file 61 of this print image 61a.

In the second embodiment, similar film images are searched for with reference to the second similarity level, which is lower than the first similarity level for the detection of corresponding film images. It is also possible to preset a third reference level or more than two reference levels for checking similarity between the print image and the film image. File names of similar film images detected with reference to the different similarity levels are written in different areas of a concerned print image file according to their respective similarity levels. The lower the reference level for similarity is preset, the more number of film images will be retrieved as similar images. The increasing number of retrieved film images may make the customer recollect the days when those images were photographed.

As a method for relating the similar film images to the print image in question, the second embodiment suggests writing the file names of the similar film images in the file of the concerned print image. Alternatively, the relation between the concerned print image and the similar film images may be written in a file separately from the image files.

In the above embodiment the storage device 44 is provided with the film image folder 44b and the print image folder 44c, so that the imported image data are sorted according the origin when stored in the storage device 44. But it is possible to store the imported image data in the same image folder. Because the image file includes the origin data, it is possible to discriminate between the film images and the print images.

Although in the above embodiment the retrieval of corresponding film images is executed with respect to those print images whose date-of-photograph cannot be extracted, it is possible to execute the retrieval of corresponding film image with respect to every print image whose image data is imported in the photo digitizer. Since the photo digitizing agent receives a number of negative filmstrips in combination with photo prints made from those negative filmstrips, consequent digital image data often include duplicate image data, that is, image data of a film image and image data of a corresponding print image. Therefore, it must be useful for the customer on arranging the image data if the image files of the digitized images include data of duplication between the film images and the print images.

As the duplication data, the file name of the corresponding film or print image is recorded in the additional data storage area of the image file of the counterpart print or film image, respectively. So the customer can check if there is a corresponding film image to a particular print image, or vise versa, on the basis of the duplication data written in the image file.

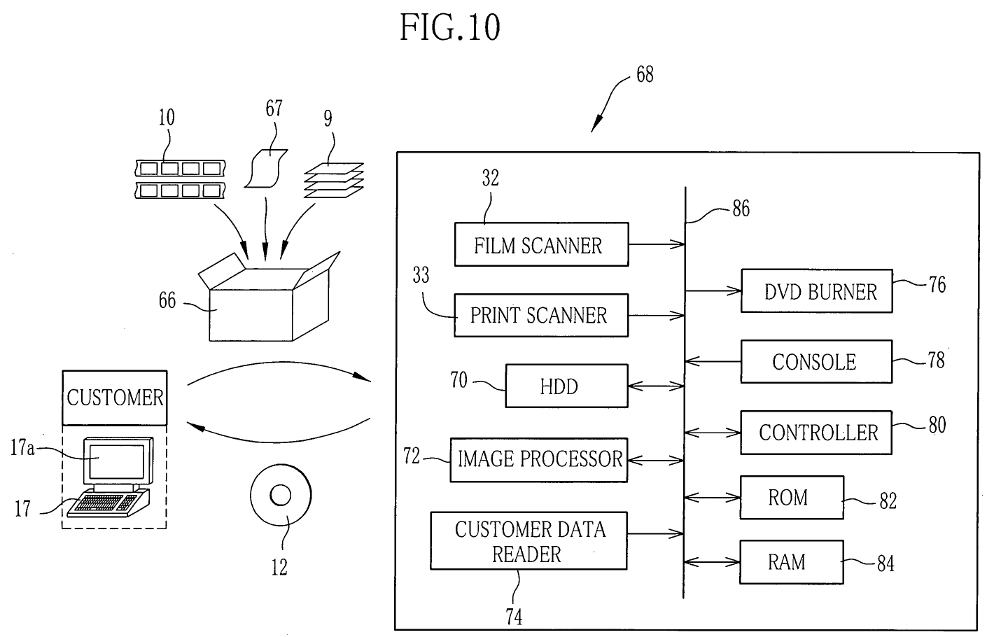

FIG. 10 shows a photo digitizing system according to another embodiment of the present invention.

A customer sends a package 66 of his or her own photo prints 9 and photo filmstrips 10 to a digitizing center 68, along with an order sheet 67. In the digitizing center 68, the photo filmstrips 10 and the photo prints 9 are scanned to pick up digital image data, and the image data are written on a storage medium 12, such as a DVD. The DVD 12 is sent back to the customer together with the filmstrips 10 and the photo prints 9. The customer can watch the images written on the DVD 12 by setting the DVD 12 in a personal computer 17.

The order sheet 67 is filled with information on the customer, including the customer's name, address, birthday, telephone number, e-mail address and the like.

The photo digitizing center 68 is constituted of a film scanner 32, a print scanner 33, a hard disc 70, an image processor 72, a customer data reader 74, a DVD burner 76, a console 78, a controller 80 for controlling these components, a ROM 82 and a RAM 84. All components of the photo digitizing center 68 are connected to each other through a data bus 86.

The film scanner 32 sequentially scans picture frames on the photo filmstrips 10 at a predetermined resolving power, to pick up image data corresponding to the respective picture frames. The image data is written on the hard disc 70 under an individual file name, “ALBUMi.jpg” for example, wherein i=1, 2, 3 . . . , that varies from one image file to another. In this embodiment, the image file is adapted to the Exif format.

The Exif image file is constituted of image data and an additional area that is called ExifTag and defined by the Exif standards. The ExifTag area is provided with an area called MakerNote, where any appropriate data can be stored in addition to photographic conditions and the date-of-photograph. The customer can add any tag to the image data, and the tag is written in the MakerNote area.

The date-of-photograph of each picture frame is detected from the photographic film 10. For this purpose, the film scanner 32 reads a DX code that is recorded as an identification number on each individual photo filmstrip 10 in the factory. By referring this DX code to a date-and-time data base that is stored in the hard disc 70, it is possible to estimate the date of manufacture of the photographic film 10. If the photographic film 10 is of IX 240 type for the APS (Advanced Photo System), it is possible to detect the date-of-photograph by reading magnetic data written on magnetic tracks on the photographic film 10.

If the date-of-photograph is superimposed on individual picture frame of the photographic film 10, the date-of-photograph can be detected through character recognition from the digital image data. If the date-of-photograph of one picture frame is not clearly determined by the character recognition, it is possible to presume the date-of-photograph with reference to the dates detected from bordering picture frames.

The print scanner 33 scans the photo prints 9 to produce image data of the photo prints 9. The image data are written on the hard disk 70 under a specific file name. If the date-of-photograph is superimposed on the photo prints 9, the date-of-photograph is detected through a character recognition process.

If any information on the time the photo print 9 was made is recorded on a margin of the photo print 9 or on the back of the photo print 9, such information may be read out and served as date data of that photo print 9.

The controller 80 produces a date index file showing correlations between the image data files and the date data detected by use of the film scanner 32 or the print scanner 33. Hereinafter, the date index file will be referred to as the date IDX file. The date IDX file is written on the RAM 84, and is revised each time an image is digitized.

The image processor 72 processes the image data from the film scanner 32 and the print scanner 33, for gradation processing, color conversion, sharpness processing and so on. The image processor 72 may also process the image data for image restoration, such as fading compensation, stain correction, and red-eye correction.

The customer data reader 74 optically reads out the information on the customer from the order sheet 67. As the customer data reader 74, a bar code reader, a mark sheet reader, an optical character reader (OCR) or the like is usable. The customer's information is written as customer data on the RAM 84. Instead of reading the customer's information optically, it is possible to input it manually through the console 78.

The DVD burner 76 records the image data files as stored in the hard disc 70, the date IDX file as stored in the RAM 84, an image display program and other data on the DVD 12. The DVD 12 is preferably a rewritable DVD-RAM, in view of that the image data files are to be added or deleted and that the date IDX file and other index files are to be revised. But the DVD 12 may be a DVD-R. Instead of or in addition to the DVD 12, other kinds of storage media, such as CD-RW, MO, optical card are usable. In that case, a CD-RW drive, a MO drive, or an optical card writing device is installed in the photo digitizing center 68 in place of or in addition to the DVD burner 76.

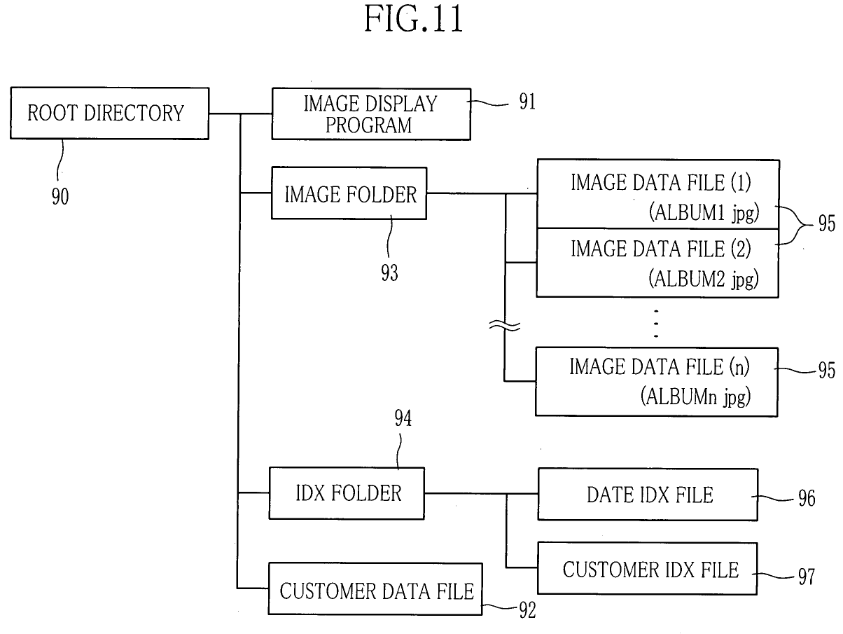

FIG. 11 shows a file structure in the DVD 12, wherein the image display program 91, a customer data file 92, an image folder 53 and an index (IDX) folder 94 are disposed under a root directory 90. The image folder 93 is provided with a plurality of image data files 95. Each image data file 95 is given an individual file name, e.g. ALBUMi.jpg, wherein “i” is the individual frame number, so that the picture frames read out from the photo prints 9 and the photographic film 10 may be identified by the individual frame number.

The IDX folder 94 is provided with a date IDX file 96 and a customer IDX file 97. The date IDX file 96 contains frame numbers in association with the date data, wherein the frame numbers are arranged in a time sequential fashion according to the associated date data. The photo prints 96 is written on the DVD 12 in the photo digitizing center 68 on the basis of the date IDX file stored in the RAM 84. The date data may be used as a search term or keyword for searching frame numbers of those images which are associated with a designated date.

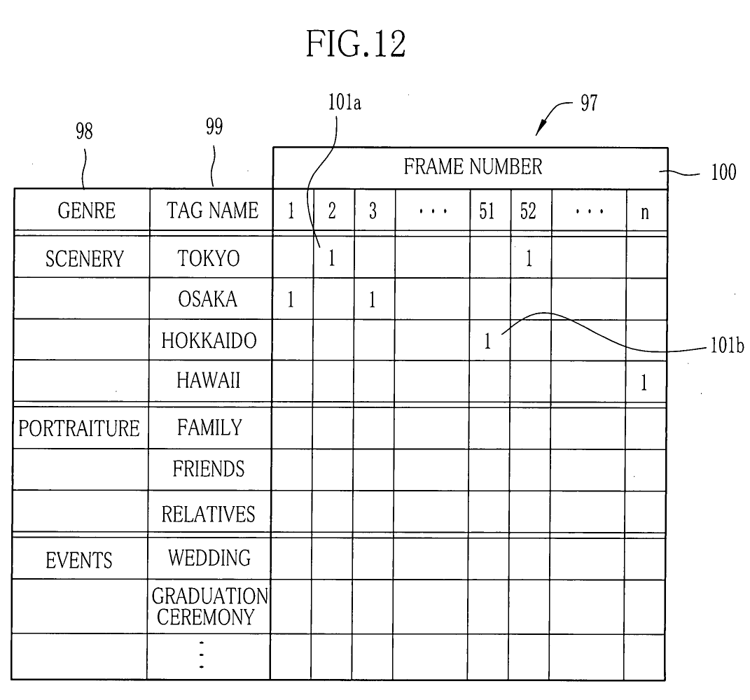

The customer IDX file 97 is produced by the customer while observing the image files. As shown in FIG. 12, the customer IDX file 97 has a genre field 98, a tag name field 99, and a frame number field 100. In the genre field 98, genre names defined by the customer, such as “Scenery”, “Portraiture” and “Events”, are written. In the tag name field 99, tag names are written as tag data for use as search terms or keywords for the data retrieval. The tag names are grouped according to the belonging genres. For example, tag names “Tokyo”, “Osaka” and “Hawaii” are grouped in the genre “Scenery”. The genres and the tag names are not limited to the illustrated embodiment, but may be defined appropriately by the customer.

In the frame number field 100, the frame numbers are arranged sequentially as identification data of the respective image data files 95, and each frame number has a flag “1” in a location corresponding to a tag name. For example, a flag 101a recorded in the second frame number field indicates that the image data file of the frame number #2 has the tag “Tokyo” that belongs to the genre “Scenery”.

If the customer puts a tag onto a particular image, while observing the images, the tag data is added to the customer IDX file 97. For example, as shown in FIG. 12, when the customer puts a tag “Hokkaido” on the image frame #51, the tag name “Hokkaido” is added to the tag name field 99, and a flag 101b is recorded in a location corresponding to the tag name “Hokkaido” in the 51^{st} frame number field.

To retrieve image data by use of the tag data, first a tag name identical to a designated keyword is detected, and then frame numbers having a flag in the corresponding location to the detected tag name are selected among from the frame number fields. Those image data files 95 having the selected frame numbers are read out from the image folder 93, to display their images.

Referring back to FIG. 2, the customer data file 92 is for recording the customer data read out through the customer data reader 74, including customer's name and birthday. The image display program 91 is a program for reading out the image data file 95 and displaying the images on a screen 17a of the personal computer 17. The image display program 91 is previously stored in the ROM 82 of the photo digitizing center 68, and is sent to the DVD burner 76 for writing it on the DVD 12.

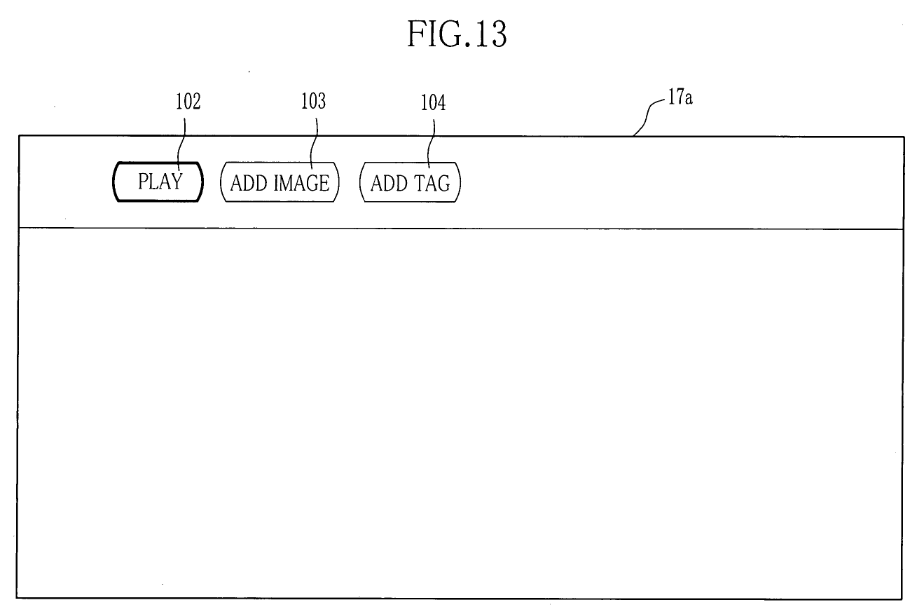

When the DVD 12 is set in a DVD drive of the personal computer 17 of the customer after the DVD 12 being received from the photo digitizing center 68, the image display program 91 is automatically read out from the DVD 12, and is activated in the personal computer 17. Then, an initial menu page is displayed on the screen 17a, as shown in FIG. 13.

On the upper side of the screen 17a are arranged a play button 102, an image add button 103 and a tag add button 104. An image display area is disposed under these buttons. When one of the buttons 102 to 104 is selected through a keyboard or a mouse attached to the personal computer 17, the personal computer 17 proceeds from this initial condition to a designated display mode.

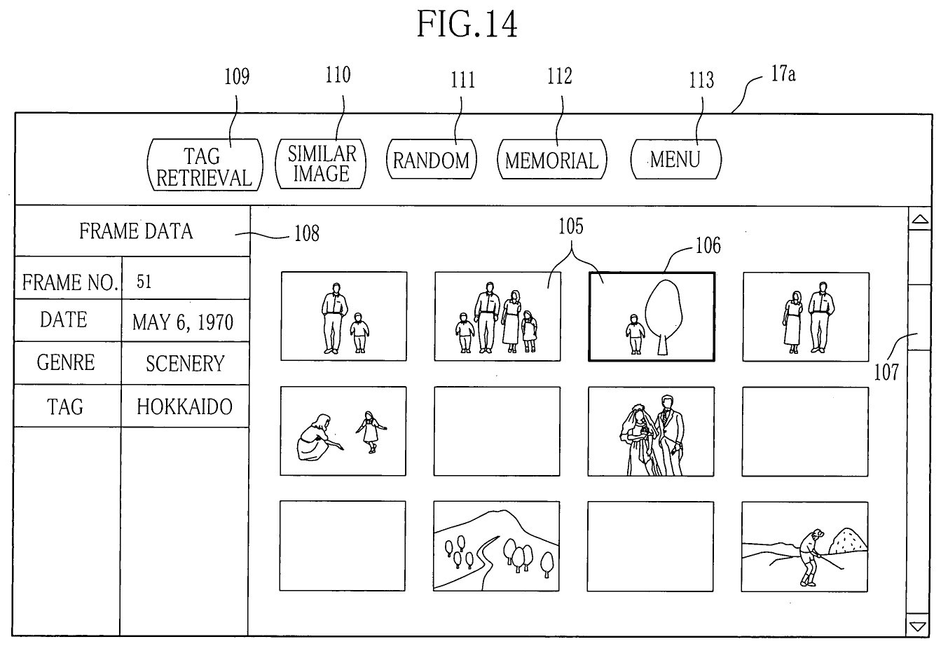

When the play button 103 is selected, the personal computer 17 proceeds to an image display mode, wherein the image data files 95 are sequentially read out from the image folder 93 of the DVD 12. Then, as shown in FIG. 14, thumbnails 105 of the respective image frames are displayed in the order of the frame numbers. Thumbnails of higher frame numbers can be displayed by operating a scroll bar 107 on the screen 17a.

On the left hand side of the screen 17a is disposed a frame data display area 108 for displaying data of a selected one of the image frames 105. The selected image frame is marked with a frame cursor 106. The frame data display area 108 has a number of fields for displaying the frame number, the date data, the genre and the tag of the selected image frame. The customer can not only confirm these data but also rewrite any one of these data. For example, if the customer rewrites the date data on the frame data display area 108, the date data stored in the ExifTag area of the image data file 95 of the selected image frame is rewritten correspondingly, and the counterpart data in the customer IDX file 97 is revised correspondingly.

If the customer changes the genre or the tag name of the selected image frame, the image display program 91 checks if there is the same data in the customer IDX file 97 as the changed genre or tag name. If yes, a flag is put in a corresponding location of the frame number field. If not, a new genre and/or a new tag name is recorded in the customer IDX file 97. In addition, the image display program 91 records the changed tag data in the MakerNote area of the concerned image data file 95.

In the image display mode, a tag retrieval button 109, a similar image searching button 110, a random display button 111, a memorial image display button 112 and a menu button 113 are displayed on the upper side of the screen 17a. The customer can select one of these buttons 109 to 113 by operating the keyboard or the mouse.

If the tag retrieval button 109 is selected, image retrieval is conducted using tag data, wherein the tag data written in the customer IDX file 97 is compared with a keyword entered by the customer. If the keyword coincides with a tag name that is stored as the tag data, those frame numbers are sorted out, which have a flag in the corresponding frame number field 100 to that tag name. Then, the images of the sorted frame numbers are displayed on the screen 17a.

For example, when “Hokkaido” is entered as the keyword for the image retrieval, the tag “Hokkaido” is detected in the customer IDX file 97, so the image data file whose frame number is “51” is sorted out as having the flag 101b in the frame number field 100 corresponding to the tag “Hokkaido”. In this way, at least an image having the tag “Hokkaido” is displayed on the screen 17a.

If the similar image searching button 110 is selected after one of the thumbnails 105 is designated by the frame cursor 106, similar images to the designated image are extracted and displayed on the screen 17a. As the method of extracting similar images, for example, a method disclosed in Japanese Laid-open Patent Application No.2000-222437 is applicable. If the random display button 111 is selected, images are displayed at random on the screen 17a. If the memorial image display button 112 is selected, images of memorial events are displayed in a sequence according to the date of photograph. It is possible to display memorial images taken in a time period designated by the customer. If the menu button 113 is selected, the initial menu page as shown in FIG. 13 appears.

When the tag addition button 104 is selected on the menu page, those image data files which do not have the date data are extracted, and the personal computer 17 proceeds to a tag addition mode. In the tag addition mode, the frame numbers of those image data files 95 having no date data are extracted with reference to the date IDX file 96, and thumbnails of the image data files of the extracted frame numbers are displayed on the screen 17a. So the customer can enter date data or tag data to a selected one of the displayed images. If any date data is entered, the date data is recorded in an related location of the date IDX file 96, while the date data is written on the ExifTag area of the concerned image data file 95. If tag data is entered, the content of the customer IDX file 97 is revised, and the tag data is written on the MakerNote area of the concerned image data file 95.

When the image add button 103 is selected on the menu page shown in FIG. 13, the personal computer 17 proceeds to an image adding mode, wherein an image data file is added and recorded on the DVD 12. In this image adding mode, it is also possible to combine different data as read out from two sheets of DVD 12, into a single folder.

To add an image data file, an individual frame number is given to the added image data file before writing it in the image folder 93. If the added image data file is provided with a tag, the tag is read out and written in the customer IDX file 97. The image display program 91 includes a table that correlates format data of each image data file to data of tag recording area, so that a recording area for the tag is detected with reference to the format of the added image data file and the above table.

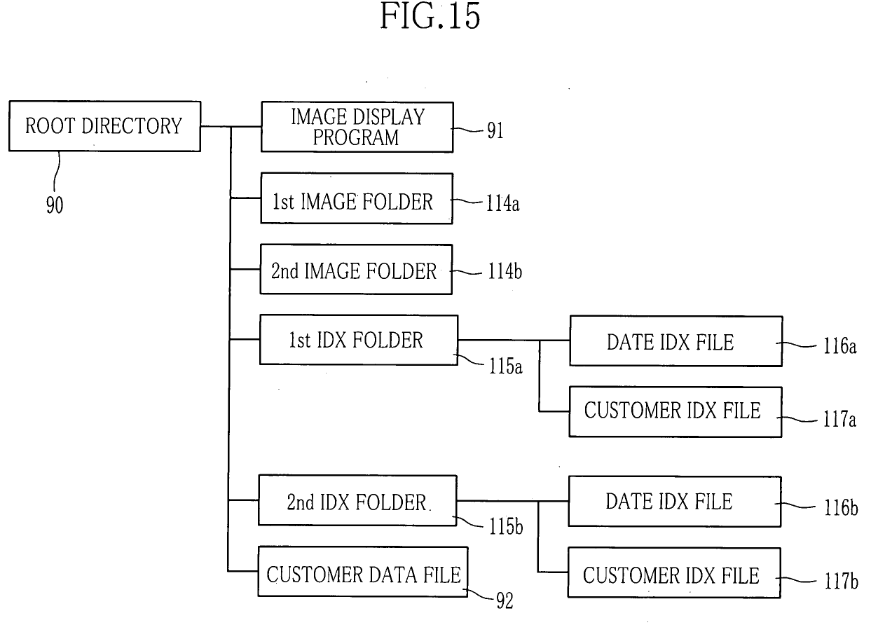

On the other hand, in order to combine data of two DVDs, the image folders 93 and the IDX folders 94 of the two DVD are combined. FIG. 15 shows an example of a file structure of combined data. In a lower stratum under the root directory 90A, a first image folder 114a and a first IDX folder 115a of one DVD, and a second image folder 114b and a second IDX folder 115b of the other DVD are created. A date IDX file 116a and a customer IDX file 117a are laid under the first IDX folder 115a, whereas a date IDX file 116b and a customer IDX file 117b are laid under the second IDX folder 115b.

In order avoid duplication of the frame numbers, it is preferable to change the frame numbers of the image data files of the second image folder 114b and the corresponding contents of the date IDX file 116b and the customer IDX file 117b as well.

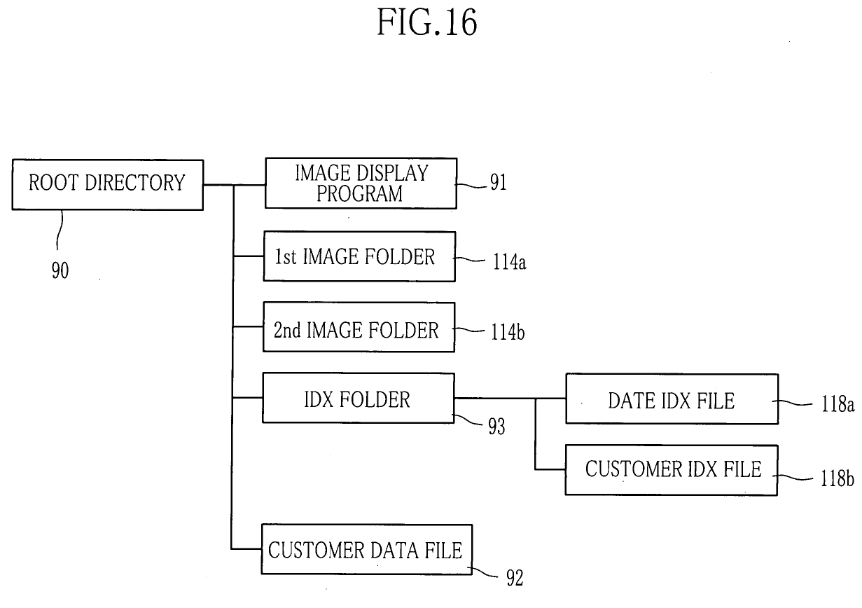

FIG. 16 shows another example of a file structure of combined data, wherein first and second image folder 114a and 114b are created in the same way as the example of FIG. 15, but date IDX files of the two DVD are combined into a date IDX file 118a and laid under a single IDX folder 93. Also customer IDX files of the two DVD are combined into a customer IDX file 118b and laid under the single IDX folder 93. In that case, it is preferable to change the frame numbers of the image data files of the second image folder 114b and the corresponding contents of the date IDX file 118a and the customer IDX file 118b as well, for the sake of avoiding duplication of the frame numbers.

It is also possible to combine the image data files of the two DVD into the same image folder. In that case, for avoiding duplication of the frame numbers, the frame numbers of all image data files are changed in an appropriate manner, and the contents in the files of the IDX folder 93 are changed correspondingly.

In addition to the image data obtained by digitizing the photo prints 9 and picture frames on the photo filmstrip 10, the DVD 12 may store still video image data and movie data obtained by digitizing movie film. In that case, the DVD 12 is provided with an Exif image folder 120 for storing image data files of the Exif format and a non-Exif image folder 121 for storing image data files of non-Exif format.

In the respective Exif image data files of the Exif image folder 120, tag data are written both in the ExifTag area of the Exif image data file and in the Exif Tag area of the customer IDX file 97. On the contrary, regarding MPEG (Moving Picture Experts Group) files 122, AVI files 123, HTML (Hyper Text Markup Language) files 124 and other non-Exif format files, because it is impossible to write the tag data directly in the files, the tag data is written in the customer IDX file 97 alone. Respective image frames, which constitute image data files and movie data files, are accompanied with individual frame numbers, so that the frame numbers will not be duplicated in the customer IDX file 97.

In order to retrieve some image frames, searching data such as a keyword is compared with the tag data stored in the customer IDX file 97, so the image frames having the corresponding tag data to the keyword are displayed on the screen 17a. Using the customer IDX file 97 in this way achieves efficient retrieval of the movie image files or still video image files even through these files cannot directly store the tag data.

Meanwhile, if the tag data of any image data file is rewritten, it is necessary to revise the content of the index files correspondingly. Therefore, processing time necessary for rewriting the data is relatively long. Furthermore, indeed it is more efficient to use the index files for the data retrieval where there are a huge number of image data files on the storage medium, but if there are a few number of image data files, it does not take much time to make the retrieval by reading out the tag data from the respective image data files, so that the merit of using the index file is not so obvious.

For this reason, it is preferable not to create an index file where the number of image data files is few. For example, if the image data files 95 in the image folder 93 are not more than a hundred, the customer IDX file 97 is not created. Then, if the tag data of an image data file is changed, only the MakerNote data in the concerned image data file 95 is revised. Thus, the processing time necessary for revising the tag data is saved. If the number of image data files goes over a hundred in the image folder, it is preferable to create the customer IDX file 97 with reference to the tag data of the respective image data files 95.

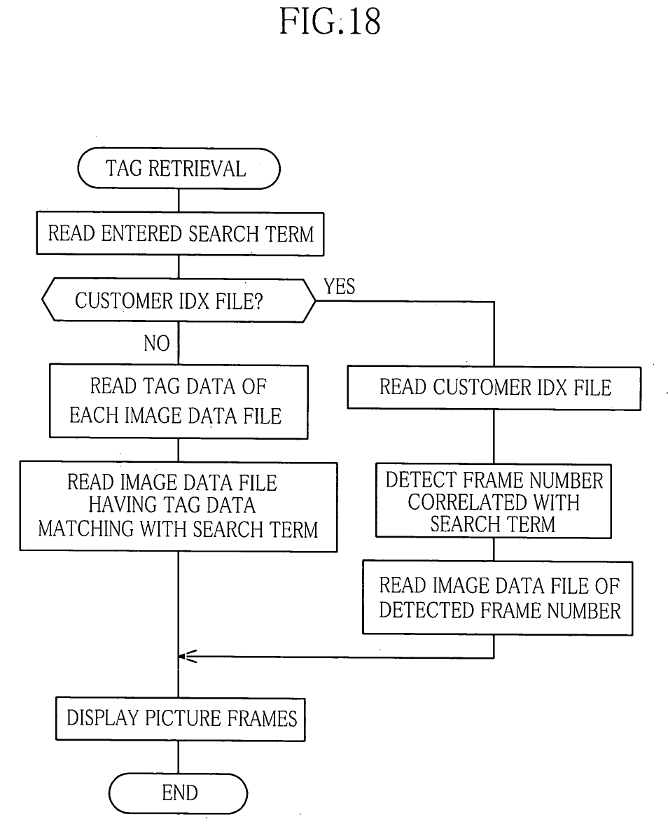

In this embodiment, the tag retrieval is conducted according to the sequence shown in FIG. 18. When a keyword is entered in the tag retrieval mode, it is checked if there is the customer IDX file 97 in the IDX folder 94. If yes, the tag data of the customer IDX file 97 is compared with the keyword, and the frame numbers of those image data files which have the corresponding tag data to the keyword are extracted, so that the image data files of the extracted frame numbers are retrieved.

On the contrary, if there is not a customer IDX file 97, the tag data written in the MakerNote areas of the respective image data files are read out and compared with the keyword. Then, an image data file having the tag data that coincides with the keyword is retrieved. At the conclusion of the retrieval, the images of the retrieved image data files are displayed on the screen 17a.

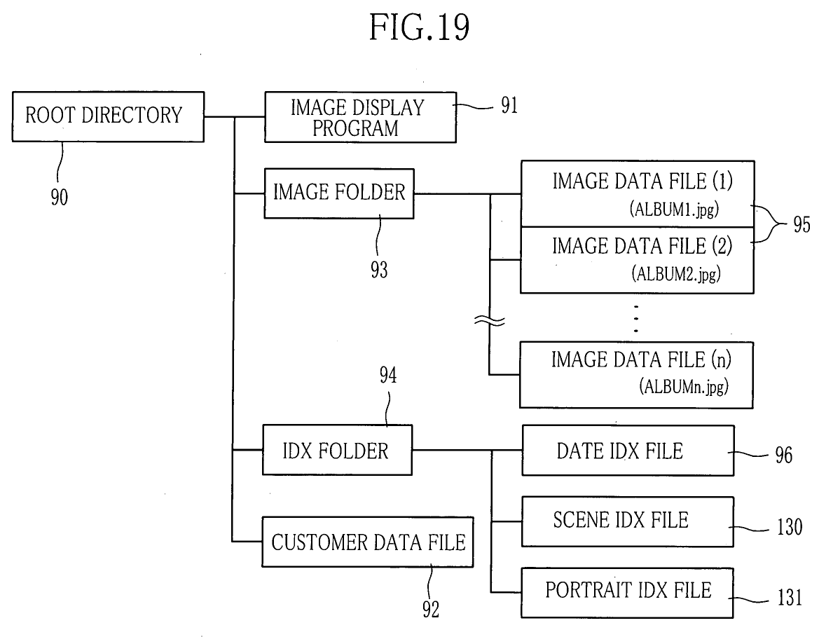

In the above embodiments, index data are written in the customer IDX file, regardless of their genres, including scenery and portraiture. It is alternatively possible to create an independent index file for each genre. For example, as shown in FIG. 19, a scene IDX file 130 for recording tag data concerning scenery and a portrait IDX file 131 for recording tag data concerning portraiture are created in a lower stratum under the IDX folder 94, in addition to the date IDX file 96. Needless to say, the names and the number of the index files are not limited to the embodiment shown in FIG. 19.

Although the customer sends the photo prints 9 or the photographic film 10 directly to the digitizing center 68 in the above embodiment, it is possible to dispose agent shops for forwarding the customer's originals through the agent shops to the digitizing center 68.

Although the above embodiments have been described on the assumption that the film images are picked up from negative filmstrips, the same applies to the cases where the film images are picked up from reversal filmstrips having positive images recorded thereon.

Thus, the present invention is not to be limited to the above embodiments but, on the contrary, various modifications will be possible without departing from the scope and spirit of the appended claims.

1. A method of determining time-of-photograph of an individual image in a photo digitizing process, wherein print images recorded as photo prints and film images recorded on photographic film are opt-electrically converted into digital image data, to record the image data on a storage medium, said method comprising the steps of:
judging similarity between two images by comparing image data of a particular print image whose date-of-photograph is not determined with image data of each of a plurality of film images, to retrieve from said plurality of film images a film image that can be judged to be corresponding to said particular print image; and
determining that the date-of-photograph of said film image as judged to be corresponding to said particular print image is the time-of-photograph of said particular print image.

2. A method of determining time-of-photograph, as claimed in claim 1, further comprising steps of extracting date-of-photograph of each individual image that may be superimposed on said image from image data obtained from said print images and said film images, and recording extracted date-of-photograph as date data in association with said image data.

3. A method of determining time-of-photograph, as claimed in claim 1, wherein said similarity judging step comprises the steps of:
predetermining a first similarity level and a second similarity level lower than said first similarity level;
judging a film image to be a corresponding image to said particular print image when the similarity of said film image to said particular print image is on said first similarity level; and
extracting, if said corresponding image is not detected, at least a film image as a similar image to said particular print image when the similarity of said at least a film image to said particular print image is on said second similarity level, and wherein said method further comprises the step of recording data of said similar image in association with data of said particular print image.

4. A method of determining time-of-photograph, as claimed in claim 3, wherein a data file name of said similar film image is recorded as said similar image data in a data file of said particular print image.

5. A device of determining time-of-photograph of an individual image in a photo digitizing apparatus, which opt-electrically scans print images recorded as photo prints and film images recorded on photographic film to convert those images into digital image data, and writes the image data on a storage medium, said device comprising:
an image retrieving device that compares image data of a particular print image whose date-of-photograph is not determined, with image data of each of a plurality of film images, to judge similarity of each of said film images to said particular print image, and retrieves from among said film images a film image that can be judged to be corresponding to said particular print image; and
a device of determining that the date-of-photograph of said film image as judged to be corresponding to said print image is the time-of-photograph of said particular print image.

6. A device of determining time-of-photograph, as claimed in claim 5, further comprising a device of extracting date-of-photograph from the image data that may be superimposed on said print images and said film images, and a device of recording extracted date-of-photograph as date data in association with said image data.

7. A device of determining time-of-photograph, as claimed in claim 5, wherein said image retrieving device judges a film image to be a corresponding image to said particular print image when the similarity of said film image to said particular print image is on a predetermined first similarity level; and if said corresponding image is not detected, said image retrieving device judges at least a film image to be a similar image to said particular print image when the similarity of said at least a film image to said particular print image is on a second similarity level that is predetermined to be lower than said first similarity level, and records data of said similar image in association with data of said particular print image.

8. A method of retrieving images from among a plurality of image data files written on a storage medium by use of search terms, comprising the steps of:
allocating identification data respectively to said plurality of image data files;
creating an index file that correlates said identification data with tag data;
revising said index file each time tag data is added to one of said image data files;
searching said index file for tag data that match with a search term entered, to extract those of said identification data which are correlated with said matching tag data; and
reading out image data files with reference to said extracted identification.

9. A method of retrieving images as claimed in claim 8, wherein said identification data are frame numbers.

10. A method of retrieving images as claimed in claim 8, wherein said search terms include keywords classifying image contents.

11. A method of retrieving images, as claimed in claim 8, wherein said search terms include date data.

12. A method of retrieving images as claimed in claim 8, wherein said plurality of image data files include files of those formats having an additional data recording area on which tag data are recordable, and files of those formats having no additional data recording area.

13. A method of retrieving images as claimed in claim 12, wherein tag data are recorded in said additional data recording area as for said image data files having said additional data recording area, whereas for those image data files having no additional data recording area, tag data are recorded in said index file in relation to the identification data of those image data files which said tag data are allocated to.

14. A method of retrieving images, as claimed in claim 13, wherein, concerning those image data files having said additional data recording area, said index file is not created until the number of said image data files comes to a preset value, and image data files are extracted by comparing said entered search term with tag data recorded in said additional data recording area of said image data files.

15. A computer program for retrieving images from among a plurality of image data files written on a storage medium by use of search terms, said program comprising program segments for causing a computer to carry out the steps of:
allocating identification data respectively to said plurality of image data files;
creating an index file that correlates said identification data with tag data;
revising said index file each time tag data is added to one of said image data files;
searching said index file for tag data that match with a search term entered, to extract those of said identification data which are correlated with said matching tag data; and
reading out image data files with reference to said extracted identification.
